(19) United States
(12) Patent Application Publication
(10) Pub. No.: US 2011/0253726 A1
(43) Pub. Date: Oct. 20, 2011

(54) LIQUID-CONTAINER COATING STRUCTURE WITH FLOWER-INDIFFERENT, PUNCTURE-WOUND, SELF-SEALING CAPABILITY

(75) Inventors: Russell A. Monk, Salem, OR (US); Thomas S. Ohnstad, Salem, OR (US)

(73) Assignee: High Impact Technology, LLC, Tigard, OR (US)

(21) Appl. No.: 13/083,559

(22) Filed: Apr. 9, 2011

Related U.S. Application Data
(60) Provisional application No. 61/342,587, filed on Apr. 16, 2010.

(51) Int. Cl. F17C 3/00

(52) U.S. Cl. 220/560.02

(57) ABSTRACT

An anti-puncture-wound, self-sealing coating structure applicable to the outside surface of a liquid-container wall having a puncture-flowering propensity. The coating structure, in operative condition relative to such a wall, includes (a) an inner, puncture-response layer disposed immediately adjacent the outside surface of the wall, formed of a flower-indifferent material possessing a thickness which is greater than the expected depth of a puncture flower produced in the wall, and (b) an outer, puncture-response layer operatively associated with the inner layer, disposed upwardly adjacent the inner layer, formed, at least in part, of a high-elastomeric material possessing a self-sealing characteristic which reacts in a self-sealing manner to any puncture-produced exposure of the outer layer material to liquid leaking from the container.

### CROSS-REFERENCE TO RELATED APPLICATION

This application claims filing date priority to U.S. Provisional Patent Application Ser. No. 61/342,587, filed Apr. 16, 2010 for “Flower-Indifferent, Puncture-Wound Self-Sealing”. The entire disclosure content of that provisional application is hereby incorporated herein by reference.

### BACKGROUND AND SUMMARY OF THE INVENTION

The present invention relates generally to outside-surface-applied, protective barrier coatings intended to provide rapid self-sealing of a liquid-container-wall puncture wound of the kind experienced, for example, in a military combat zone from a container-piercing bullet strike. Notably, and as is often the case with such an event, container piercing is characterized by paired, entrance and exit, wall-penetration wounds.

In relation to addressing this problem heretofore, there have existed several, available, container-wall-outside-applicable, self-sealing, protective type coatings which have been proposed in the past to protect against this kind of puncture-wound occurrence and condition. Typically, such protective coatings have worked relatively well, and in some instances very well, with respect to self-sealing against leakage from an entrance wound, regarding which a punctured container wall normally flowers (or blossoms) inwardly, i.e., toward the inside of the protected container. This concept of flowering or blossoming is well known in the relevant art with respect to piercing type wounds which take place, for example, in relatively ductile metals.

These same protective coatings, however, often work not so well with respect to an exit wound, where container-wall damage includes an outwardly extending flower (or blossom) which can function unwantedly to hold open such a wound, notwithstanding the presence at that location of the very same kind of outer protective coating which works effectively with respect to the paired, associated entrance wound. Such an outwardly extending flower can prevent material in the relevant protective coating from “rejoining”, i.e., closing upon itself, to effect a seal against container-held liquid leakage.

The present invention addresses this issue by proposing a unique, plural-layered protective coating, applicable to the outside surface of a liquid container wall and employing, preferably, in combination, (1) an inner layer, disposed functionally closest to the protected container, formed of a three-dimensional-woven, flowering-indifferent (or flower-indifferent), spatial fabric material characterized by having a core “jungle” expanse of elongate, plastic fibres wandering in a core open space—this inner layer being covered on opposite broad faces with a thin, material-containment, fabric web of a material, such as nylon or the like, joined operatively to (2) an outer, self-sealing, liquid-reactant coating layer having a high-elastomeric nature.

In this invention-proposed, layered coating structure, the inner-layer, three-dimensional fabric, as illustrated and described herein, prevents an outwardly flowering exit wound in a container wall from holding open a leakage passage which the outer-layer overcoating of elastomeric material might be unable, without the “help” of the inner layer, to seal effectively. Such an outwardly flowering exit wound is, in accordance with the proposed structure and behavior of the present invention, effectively defeated by the fact that the thickness of the three-dimensional, flowering-indifferent fabric is preferably no less than, and even more preferably more than, the anticipated, outward extent or dimension of a penetration-type, exit-wound flower. Because of this construction, such a flower, which truly exists, “deploys and remains” within the thickness dimension of the three-dimensional fabric. The structure of this fabric, defined as it is by a large amount of open space through which a tangled web of fibres wander, easily accommodates this behavior with the result that a puncture produced flower does not generate any bulge or other configurational change apparent on the outer surface side of the three-dimensional fabric.

The outer, self-sealing, high-elastomeric layer, mentioned above as being a part of the present invention, is preferably made in accordance with the teachings of U.S. Pat. No. 7,169,452, issued Jan. 30, 2007, for “Projectile Barrier and Method”, and particularly in accordance with what is shown in FIGS. 3 and 4 in this patent. Given this condition, the entire content of this '452 patent is hereby incorporated herein by reference, and the coating structure of the present invention is illustrated and described herein specifically with its outer layer portion made, preferably, like the barrier structure of FIGS. 3 and 4 in this patent. Put another way, the materials, the making, and the self-sealing performance, of this patented, FIGS. 3 and 4 barrier structure fully characterize the preferred and best-mode embodiment of the present coating structure's outer layer portion, and the reader of this disclosure is therefore invited to review the '452 patent for more elaboration regarding the “present” outer layer portion.

There is certain terminology which has been employed hereinabove, and which continues to be employed below in the description and characterization of the invention, which terminology should be understood have the following meanings. The terms “flower” and “blossom” (terms that are well understood in the art) refer to the surface-protruding, jagged, flower-like pierce-deformation which occurs in a ductile material when it is penetrated by an impacting object, such as a bullet. “Blossom depth”, or “flower depth”, means the depth of extension of a flower from the surface from which it protrudes. The term “puncture-flowering potential”, or “puncture-flowering propensity”, relates to a material, such as a ductile metal, which responds to such a penetrating or piercing wound by developing such a flower or blossom. A “flower-indifferent” or “flowering-indifferent” material is one which, without flowering in response to a piercing wound, effectively can contain a flower produced in an immediately adjacent material in a manner which substantially receives and hides the flower in this material without there being any significant, or even much apparent, exit-area deformation in what can be seen as the exit surface of the material.

Continuing, the term “material-containment” is employed herein with reference to a thin fabric which is employed on opposite sides of a flower-indifferent material, and specifically on opposite sides of a mat of such material, nominally to help generally hold and contain that mat material in an appropriate mat form. The terms “self-sealing reaction” and “self-sealing characteristic” are employed to describe a material function involving the material's capability to self-seal a puncture wound in response, and in relation, as a consequence of a chemical reaction which takes place between the material, or something contained in the material, and a specific, leaking liquid, such as leaking fuel. The term “high-elastomeric” refers to a material which operates within an elastic limit—its own elastic limit—when it responds to deformations residing in the range of up to, for example, about 400% elongation.

Featured by the present invention is an anti-puncture-wound, self-sealing coating structure applicable to the outside surface of a liquid-container wall having a puncture-flowering propensity, with this coating structure, in an operative condition relative to (i.e., applied to) such a wall, including (a) an inner, puncture-response layer disposed immediately adjacent the outside surface of the wall, formed of a flower-indifferent material possessing a thickness which is greater than the expected depth of a puncture flower produced in the wall, and (b) an outer, puncture-response layer operatively associated with the inner layer, disposed upwardly adjacent the inner layer, and formed, at least in part, of a high-elastomeric material possessing a self-sealing characteristic which reacts in a self-sealing manner to any puncture-produced exposure of the outer layer material to liquid leaking from the container.

Another way to express the structure of the invention is that it is an overall flower-indifferent structure applicable to the outside surface of, for self-sealing against liquid leakage from a puncture wound in, the wall of a liquid container. This structure features operatively joined, inner and outer layers—the inner layer taking the form of a containing-fabric-surfaced, three-dimensional-knit, spatial fibre mat expanse having a thickness which preferably is no less than the anticipated depth of an outwardly extending (blossoming) puncture-exit-wound flower, and the outer layer takes the cooperative form of an elastomer which incorporates, and/or directly is, a material characterized by a self-sealing reaction which becomes “operatively expressed” in relation to contact with the specific liquid which is held in the protected container.

The present invention may also be described as an anti-puncture-wound, self-sealing coating structure applicable to the outside surface of a liquid-container wall having a puncture-flowering propensity, this coating structure, in operative condition relative to such a wall, including (a) an inner, puncture-responsive layer disposed immediately adjacent the outside surface of the wall, formed of a three-dimensional-knit, fibre material possessing a thickness which is greater than the expected depth of a puncture flower produced in the wall, and (b), operatively associated with the inner layer, an outer layer disposed outwardly adjacent the inner layer, formed of a high-elastomeric material possessing a self-sealing characteristic which reacts in a self-sealing manner to any puncture-produced exposure of the inner layer material to liquid leaking from the container.

These and other features and advantages that are offered by the anti-leakage, puncture-wound sealing, protective barrier/coating structure generally described above become more fully apparent as the detailed description of the invention which follows below herein is read in conjunction with the accompanying drawings.

### DESCRIPTIONS OF THE DRAWINGS

FIG. 1, which relates to a prior-art setting, presents a simplified, cross-axial, cross-sectional view taken through a cylindrical fuel (liquid) container, or tank, generally illustrating the appearances and conditions therein of related bullet-pierce entrance and exit puncture wounds that are related to one another, and that have produced, respectively, inwardly directed, and outwardly directed, flowers, or blossoms, as discussed above in the Background and Summary of the Invention.

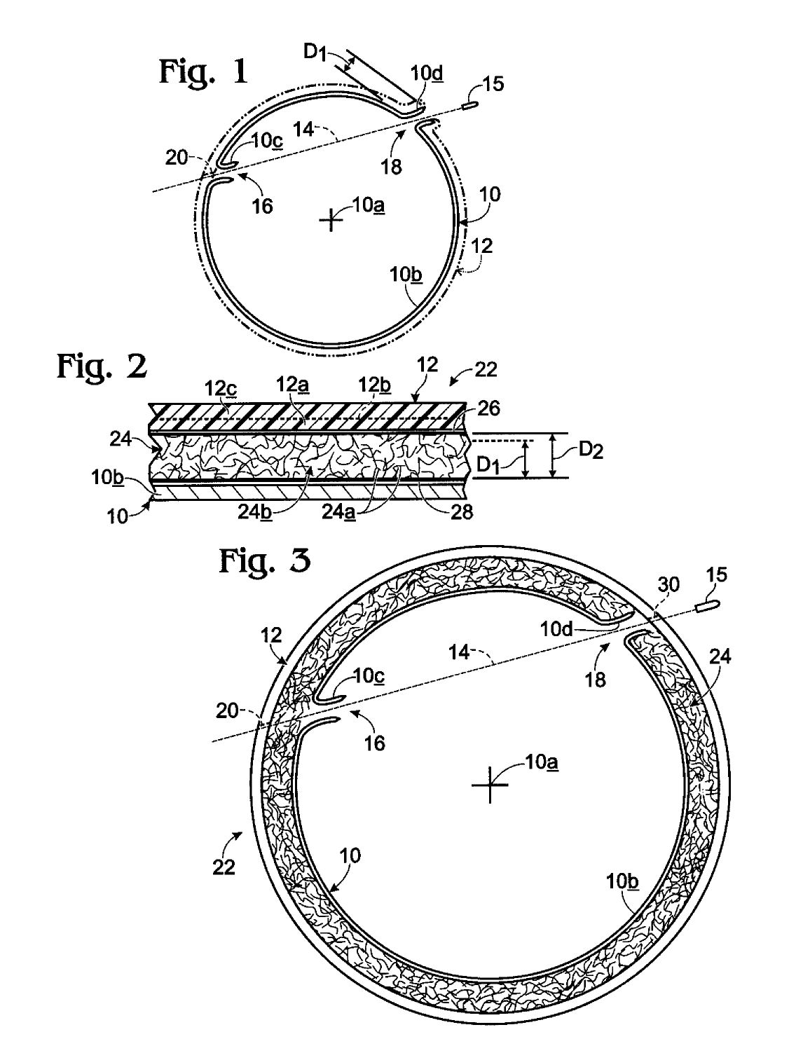

This figure, in a generally circular dash-double-dot line that appears on the outside of the illustrated fuel container, shows, at the respective locations of the entrance and exit puncture wounds, specific material behavioral conditions of an applied, prior-art, outside, elastomeric, self-sealing barrier coating of the type generally discussed above, and specifically described in the '452 patent, which, under many circumstances (except that which is particularly illustrated in FIG. 1) is successful in closing quickly a puncture wound to stop the flow of wound-produced leaking fuel. What one can observe here is, that, in the particular illustration provided in FIG. 1, this barrier coating has closed effectively the entrance wound, but has been held open in a condition unable to close the exit wound because of the nature and depth of the exit-wound flower which has been created.

FIG. 2 is an enlarged-scale, flattened, fragmentary, cross-sectional view taken through a barrier, anti-leakage, self-sealing, overall flowering-indifferent, coating structure, prepared on the outside of a liquid container wall (Illustratively, the wall of the container seen in FIG. 1) in accordance with a preferred and best-mode embodiment of the present invention, and designed to be effective to close, in addition to all puncture entrance wounds, substantially all puncture exit wounds in such a container. It is this coating structure which resolves the exit-wound non-closure problem seen in FIG. 1.

FIG. 3, which is drawn on a scale that is intermediate those scales employed respectively in FIGS. 1 and 2, illustrates the liquid fuel container of FIG. 1 possessing the same entrance and exit, bullet-pierce wounds as those shown in FIG. 1, but with the container in this instance having had applied to its wall's outside surface, a barrier coating like that pictured fragmentarily in FIG. 2, with clear illustrations present in FIG. 3 showing how this coating structure of the present invention has been effective to close both wounds that are pictured in FIG. 3.

In FIGS. 2 and 3, the internal, knit fibre structure present in one of the coating-structure-included layers is pictured only schematically, and specifically with easily drawn fibre fragments, and thus without special drawing effort to create, per se, a continuous, extending-fibre look. One should note, however, that this knit structure does indeed have a structure which includes wandering, long, continuous fibres.

Relative dimensions, and material proportions, are not necessarily drawn to scale in these drawing figures.

### DETAILED DESCRIPTION OF THE INVENTION

Turning now to the drawings, and referring first of all to FIG. 1 which illustrates, as mentioned just above, a prior-art setting and a problematic, liquid-fuel-container puncture situation in that setting, indicated generally at 10 is a cylindrical, steel fuel container which is shown in long, central-axial cross section, with its central, long axis shown generally at 10a. Fuel in the container 10 is not specifically illustrated in this figure.

Applied to the outside of the wall 10b in container 10, and illustrated very generally by a dash-double-dot line 12, is a prior-art, three-sublayer, protective, self-sealing, high-elastomeric barrier coating which has been made, and which performs, in accordance with the teachings of above-referred-to U.S. Pat. No. 7,169,452, and specifically, as mentioned earlier herein, in accordance with what appears in FIGS. 3 and 4 of this patent. As will be stated later herein, this same king of elastomeric layer is employed in the new coating structure of the present invention as one of the two, included, key response layers.

As can be seen in this FIG. 1, coating 12, which is capable of sealing most puncture wounds (in accordance with the teachings of the associated '452 patent), has been subjected to a condition—that illustrated in FIG. 1—wherein a bullet attack, occurring along the dashed trajectory line, shown at 14, of a bullet 15, has produced two, associated, container-piercing puncture wounds, shown at 16, 18, one of which wounds, namely wound 18, coating 12 has been unable to seal. More specifically, wound 16, an entrance wound created by the bullet which has struck the container, has produced, in the wall of container 10, an inwardly directed, inwardly projecting entrance-damage flower 10c, whereas wound 18, an exit wound, has produced an outwardly directed, outwardly projecting, similar, exit-damage flower 10d.

What one can thus see illustrated schematically in FIG. 1 is that, whereas protective coating 12 has been effective, as illustrated by a short, dashed line 20 which appears on the left side of container 10, to seal entrance wound 16, it has been unable to seal exit wound 18 for the reason that the outwardly projecting flower, shown at 10c, is such, in relation to its outward, projection depth D₁, and in relation to the thickness and material structure of coating 12, that it effectively holds open the exit wound, and specifically the punctured, coating structure material immediately adjacent this wound, in a manner (purposely exaggerated in FIG. 1 for emphasis) which does not permit the protective coating material to close up upon itself to effect a seal.

It is this FIG. 1. exit-wound situation which is specifically addressed correctively by the present invention.

A point, and associated comments, which should be made at this time in the description of the present invention is that, in determining how to address the specific, useful dimensional characteristics of the protective coating structure of the present invention for a particular liquid container, it is important, and this is entirely within the skill of those skilled in the art, to pre-know certain things about the nature, and the intended, spatially-positioned use, of that particular container. For example, it is important to know, as accurately as possible, how that material will respond with regard to the “production” in it of penetration blossoms, or flowers, that are expected to develop from penetration wounds that may be created along also-expected, pre-assessed, potential lines of damaging impact. Additionally, and where, for example, a container to be protected is a fuel container present on a vehicle, or in some other kind of association, deployed in a military combat zone, it is also important to have a very good idea of the nature, and by that we mean the make-up, the diameter size, and the expected impact-velocity characteristics, of a projectile, such as a bullet, which is expected to pose a potential threat for container puncture. What is important to learn from these easily made predeterminations, in terms of planning the most appropriate, container-application, thickness-sizing for the coating to be applied and used in accordance with practice of the present invention, is the expected maximum exit-wound, blossom-damage blossom depth which may occur. This dimension, as will become apparent, is important specifically in terms of best predetermining an appropriate layer thickness for one of the two, sealing-responsive layers that are present in the coating structure of the present invention.

Directing attention now to FIGS. 2 and 3, as was mentioned above in the Descriptions of the Drawings, these two figures illustrate an anti-puncture-wound, self-sealing coating structure which is made in accordance with a preferred and best-mode embodiment of the present invention suitably applied to the outside surface of the wall 10b in the same fuel container 10 which is shown in, and which has been discussed in relation to, FIG. 1.

Beginning with what is shown in FIG. 2, and recognizing, as mentioned above, that, for illustration purposes, this figure shows a flattened, fragmentary portion of both container 10, container wall 10b, and the coating structure of the present invention, this coating structure is shown generally at 22. As has been discussed herein already, coating structure 22 is, in an overall manner of speaking, a flower-indifferent, or flowering-indifferent, coating structure, in the sense that it will function to defeat the non-exit-wound closure problem shown in FIG. 1.

Coating structure 22 includes an inner, puncture-response layer 24 formed as a mat specifically of a flower-indifferent material possessing a thickness D₂ whose measure lies appropriately, and for most applications, as we have determined, typically in the range of about ⅜- to about ½-inches. This D₂ dimension, importantly, is preferably greater than, and always preferably never less than, the expected depth of a puncture flower, herein pictured at D₁, expected to be produced in the wall of an associated container, such as in wall 10b, in relation to the expected, maximum-size (i.e., maximum depth) puncture-wound flower anticipated for expected, potential puncture-wound threats, such as that posed by the bullet strike illustrated in FIGS. 1 and 3. Dimensions D₁ and D₂ also appear in FIG. 1 in a manner helping to explain visually why exit wound 18 has not been sealed in the situation shown there.

This flower-indifferent material takes the form herein preferably of a three-dimensional, spatial, knit fabric (a term known in the art) which is a fabric formed with a core knit “jungle” or “tangle” expanse of elongate, plastic fibres, such as those shown simply (as explained earlier) as fibre fragments at 24a, which effectively wander in a substantial-size core “space” 24b. A preferred three-dimensional knit fabric which is usable very effectively in the coating structure of the present invention is one that is made, as Product (or Part) # SHR705/60, Black, No. 9321, by Gehring Textile, Inc., Garden City, N.Y., 11530.

Spatial fabric material (layer) 24 is conveniently covered on its opposite broad faces by what are referred to herein as material-containment layers of thin fabric, such as, for example, nylon. These two containment-material layers are shown in FIG. 2 at 26, 28. The assembly of inner layer 24 and material-containment layers 26, 28, is applied and adhered to the outside surface of the wall 10b in container 10 in any appropriate fashion, as by gluing. Suitable gluing materials include, for example, what is known as a slow-curing version of the TUFF STUFF® FR material mentioned later herein, and also, any suitable contact adhesive.

Formed preferably by spray-application to the outer surface of material-containment-layer 26 is what is referred to herein as an outer, self-sealing, high-elastomeric, puncture-response layer that intentionally bears, in FIGS. 2 and 3 herein, the same reference numeral 12 which appears for structurally the same layer pictured in FIG. 1. Layer 12, as discussed in relation to FIG. 1, is formed of material possessing what has been referred to as a self-sealing characteristic—a characteristic which causes the material to react in a self-sealing manner to any puncture-produced exposure of the material to fuel leaking from container 10. This outer layer 12, now organized (as distinguished from its “solo” inclusion in the setting shown in FIG. 1) in a cooperative relationship with spatial-fabric inner layer 24, is made herein, preferably, in accordance with the teachings of FIGS. 3 and 4 in the '452 patent, and, as is illustrated schematically in the FIG. 2, includes three sublayers 30a, 30b, 30c. Sublayers 30a, 30c are formed entirely of the high-elastomeric material described in the '452 patent, and sublayer 30b, which is shown herein simply as a darkened dashed line within layer 30, is formed with a body of the same, just-mentioned, high-elastomeric material, in which there is an embedded population of liquid-imbiber beads, made from the same beads described in the '452 patent.

The elastomeric material herein takes the form of the material sold under the trademark TUFF STUFF® FR, made by Rhino Linings USA, Inc. in San Diego, Calif., and the imbiber bead material preferably employed is sold under the product designator IMB230300, made by Imbibitive Technologies in Midland, Mich. The overall thickness of layer 30 typically resides in the range of about ½- to about 11/16-inches.

While this three-sublayer arrangement is a preferred structural arrangement for layer 12, it is possible to employ, as an effective outer layer 12, a structure which does not necessarily include the mentioned, embedded, liquid-imbiber beads.

FIG. 3 clearly illustrates how the two-response layer structure of the present invention functions to solve the exit-wound-closure problem pictured in FIG. 1. More specifically, what is plainly evident in FIG. 3 is that, given appropriate dimensionality for the thickness of the spatial fiber layer in the coating, an exit wound flower created as a consequence of a puncture wound, like flower 10d in puncture wound 18, becomes “received” and essentially contained entirely within the fiber-surrounding space which characterizes layer 24. An obvious result of this is that there is little to no bulge or other configurational change which occurs on the outer side of layer 24—a change which would in any manner prevent the high—elastomeric, outer, self-sealing layer, from performing its function of producing an effective anti-leakage seal, such as the seal shown at 30 in FIG. 3.

One interesting possibility for creating an alternative form of coating is that the relatively large amount of open space which is present in the spatial fabric material layer, 24, might be filled, or otherwise pre-armed, with some additional, useful material which might, for example, be a special fire-suppressant material.

Accordingly, there are illustrated and described herein a special coating structure, and certain variations thereof, which may be applied to different kinds of liquid containers to prevent the exit-wound-closure problem discussed and illustrated herein. Variations in the structure, including selected-materials variations, which are appropriate to the respective required tasks, and the considerations regarding the coating dimensional aspects based upon pre-determination of expected penetration flower conditions, have been described, and are expected and intended to come within the scope of the claims presented below herein. Other variations and modifications which also come within the scope and spirit of the present invention, may also be determined by those of skill in the relevant art.

We claim:

1. An anti-puncture-wound, self-sealing coating structure applicable to the outside surface of a liquid-container wall having a puncture-flowering propensity, said coating structure, in operative condition relative to such a wall, comprising
an inner, puncture-response layer disposed immediately adjacent the outside surface of the wall, formed of a flower-indifferent material possessing a thickness which is greater than the expected depth of a puncture flower produced in the wall, and
an outer, puncture-response layer operatively associated with said inner layer, disposed upwardly adjacent said inner layer, formed, at least in part, of a high-elastomeric material possessing a self-sealing characteristic which reacts in a self-sealing manner to any puncture-produced exposure of the outer layer material to liquid leaking from the container.

2. The coating structure of claim 1, wherein said outer-layer's elastomeric material's self-sealing characteristic takes the structural form of at least one of (a) an inherent, self-sealing reaction to contact with container-held fluid, and (b) the presence within the elastomeric material of a distributed, self-sealing, liquid-reaction substance embedded within the outer layer material.

3. The coating structure of claim 1 which further comprises a pair of fabric, material-containment layers disposed adjacent, and on opposite sides of, said inner layer.

4. The coating of the claim 3, wherein said inner layer is attached to the container-wall surface through one of said material-containment layers as by gluing, and said outer layer is structured as a spray-formed layer applied, effectively, to said inner layer via the other one of said material-containment layers.

5. An anti-puncture-wound, self-sealing coating structure applicable to the outside surface of a liquid-container wall having a puncture-flowering propensity, said coating structure, in operative condition relative to such a wall, comprising
an inner, puncture-responsive layer disposed immediately adjacent the outside surface of the wall, formed of a three-dimensional-knit, fibre material possessing a thickness which is greater than the expected depth of a puncture flower produced in the wall, and
operatively associated with said inner layer, an outer layer disposed outwardly adjacent said interlayer, formed of a high-elastomeric material possessing a self-sealing characteristic which reacts in a self-sealing manner to any puncture-produced exposure of the inner layer material to liquid leaking from the container.

6. The coating of claim 5 which further comprises a pair of fabric, material-containment layers disposed adjacent, and on opposite sides of, said inner layer.

7. The coating of the claim 6, wherein said self-sealing characteristic takes the form of at least one of (a) self-sealing reaction to contact with container fluid, and (b) the presence of a self-sealing, liquid-reaction sub-material embedded with in the outer layer material.

8. The coating of claim 5, wherein said flower-indifferent inner layer material possesses a contained open space quality which causes it, on the occurrence of outward puncture-produced flowering in the container wall, to receive a produced puncture flower without there also occurring any appreciable, outwardly adjacent configuration change in the outer-side appearance of the inner layer.
